(19) United States
(12) Patent Application Publication
(10) Pub. No.: US 2020/0125354 A1
(43) Pub. Date: Apr. 23, 2020

(54) SOFTWARE UPDATE SYSTEM, SOFTWARE UPDATE METHOD, AND SOFTWARE UPDATE SERVER

(71) Applicants: HYUNDAI MOTOR COMPANY, Seoul (KR); KIA MOTORS CORPORATION, Seoul (KR)

(72) Inventor: Yun Young KIM, Suwon-si (KR)

(21) Appl. No.: 16/270,150

(22) Filed: Feb. 7, 2019

(30) Foreign Application Priority Data
Oct. 18, 2018 (KR) 10-2018-0124295

(51) Int. Cl. G06F 8/65

(52) U.S. Cl. CPC G06F 8/65

(57) ABSTRACT

A software update system is capable of detecting an error in hardware or software and executing software update corresponding to the detected error. The software update system includes: a vehicle on which first software is installed; and a server apparatus in which second software that is the same as the first software is stored and which is configured to transmit update data for updating the first software to the vehicle. The server apparatus includes: an input/output interface configured to receive environmental information or operation information of the vehicle from the vehicle; and a software update unit configured to generate update data of the first software based on an output of the second software according to the environmental information or operation information of the vehicle. The input/output interface transmits the update data of the first software to the vehicle.

### CROSS-REFERENCE TO RELATED APPLICATION

This application is based on and claims priority under 35 U.S.C. § 119 to Korean Patent Application No. 10-2018-0124295, filed on Oct. 18, 2018 in the Korean Intellectual Property Office, the disclosure of which is incorporated herein by reference.

### BACKGROUND

### 1. Field

The present disclosure relates to a software update system, a software update method, and a software update server, and more specifically, to a software update system, a software update method, and a software update server capable of updating control software of a vehicle.

### 2. Description of the Related Art

Generally, a vehicle refers to a movement apparatus or transportation apparatus, designed to run on a road or railway using fossil fuel, electric power, and the like as a power source.

In recent years, a vehicle not only serves to transport commodities and passengers but also has an audio device and a video device that allows a driver to listen to music and watch an image while driving, and the vehicle is also provided with a navigation device that displays a route to a destination desired by a driver.

The vehicle is equipped with various electric or electronic devices. The vehicle does not only include convenience devices, such as an audio device, a video device, a navigation device and the like, but also include other electric or electronic devices, such as an engine management system (EMS), a transmission control unit (TCU), an electronic stability control (ESC), a motor-driven power steering (MDPS), and the like that are related to running of a vehicle (a device for running).

### SUMMARY

Therefore, it is an aspect of the present disclosure to provide a software update system capable of detecting an error in hardware or software in the entire vehicle, and executing software update in response to the error detected.

It is another aspect of the present disclosure to provide a software update system capable of updating software of a vehicle in association with a server apparatus.

Additional aspects of the invention will be set forth in part in the description which follows and, in part, will be obvious from the description, or may be learned by practice of the invention.

Therefore, it is an aspect of the present invention to provide a software update system including: a vehicle on which first software is installed; and a server apparatus in which second software that is the same as the first software is stored and which is configured to transmit update data for updating the first software to the vehicle, wherein the server apparatus includes: an input/output interface configured to receive environmental information or operation information of the vehicle from the vehicle; and a software update unit configured to generate update data of the first software based on an output of the second software according to the environmental information or operation information of the vehicle, wherein the input/output interface transmits the update data of the first software to the vehicle.

The server apparatus may include: a database in which the second software is stored; and a simulation unit configured to input the environmental information or operation information of the vehicle to the second software and determine an error of the first software based on the output of the second software.

The simulation unit may determine a validity of the environmental information or operation information of the vehicle, and determine the error of the first software based on a result of the determination on the validity of the environmental information or operation information of the vehicle.

The simulation unit may determine a validity of the output of the second software according to the input of the environmental information or operation information of the vehicle, and determine the error of the first software based on a result of the determination on the validity of the output of the second software.

The simulation unit may predict an operation of the vehicle based on the output of the second software and determine the error of the first software based on the operation of the vehicle.

The software update unit may update the second software based on the update data of the first software.

The software update system may further include another vehicle in which third software is installed, wherein the server apparatus generates update data of the third software based on the environmental information or operation information of the vehicle and transmits the update data of the third software to the other vehicle.

It is another aspect of the present invention to provide a software update method including: storing second software that is the same as first software installed in a vehicle; receiving environmental information or operation information of the vehicle from the vehicle; and generating update data of the first software based on an output of the second software according to the environmental information or operation information of the vehicle; and transmitting the update data of the first software to the vehicle.

The generating of the update data of the first software may include: inputting the environmental information or operation information of the vehicle to the second software; and determining an error of the first software based on the output of the second software.

The determining of the error of the first software may include: determining a validity of the environmental information or operation information of the vehicle; and determining the error of the first software based on a result of the determination on the validity of the environmental information or operation information of the vehicle.

The determining of the error of the first software may include: determining a validity of the output of the second software according to the input of the environmental information or operation information of the vehicle; and determines the error of the first software based on a result of the determination on the validity of the output of the second software.

The determining of the error of the first software may include: predicting an operation of the vehicle based on the output of the second software; and determining the error of the first software based on the operation of the vehicle.

The software update method may further include updating the second software based on the update data of the first software.

The software update method may further include: generating update data of third software installed in another vehicle based on the environmental information or operation information of the vehicle; and transmitting the update data of the third software to the other vehicle.

It is another aspect of the present invention to provide a software update server including: an input/output interface configured to receive environmental information or operation information of a vehicle in which first software is installed from the vehicle; a database in which second software that is the same as the first software is stored; a simulation unit configured to input the environmental information or operation information of the vehicle to the second software and determine an error of the first software based on an output of the second software; and a software update unit configured to generate update data of the first software based on occurrence of an error of the first software, wherein the input/output interface transmits the update data of the first software to the vehicle.

The simulation unit may determine a validity of the environmental information or operation information of the vehicle, and determine the error of the first software based on a result of the determination on the validity of the environmental information or operation information of the vehicle.

The simulation unit may determine a validity of the output of the second software according to the input of the environmental information or operation information of the vehicle, and determine the error of the first software based on a result of the determination on the validity of the output of the second software.

The simulation unit may predict an operation of the vehicle based on the output of the second software and determine the error of the first software based on the operation of the vehicle.

The software update unit may update the second software based on the update data of the first software.

The software update unit may generate update data of third software installed in another vehicle based on occurrence of an error of the first software and transmits the update data of the third software to the other vehicle.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a diagram illustrating a software update system according to one embodiment.

FIG. 2 is a diagram illustrating an example of a vehicle according to an embodiment.

FIG. 3 is a diagram illustrating a configuration of a vehicle according to an embodiment.

FIG. 4 is a diagram illustrating an example in which vehicle related information is transmitted to a server apparatus according to an embodiment.

FIG. 5 is a diagram illustrating a configuration of a server apparatus according to an embodiment.

FIG. 6 is a diagram illustrating an example in which a server apparatus detects an error of a vehicle according to an embodiment.

FIG. 7 is a diagram illustrating an example in which a server apparatus verifies sensing data of a vehicle according to an embodiment.

FIG. 8 is a diagram illustrating an example of an operation of a software update system according to one embodiment.

FIG. 9 is a diagram illustrating an example of an operation of a software update system according to another embodiment.

### DETAILED DESCRIPTION

Hereinafter, the operating principles and embodiments of the disclosed will be described with reference to the accompanying drawings.

Various electric or electronic devices in a vehicle are equipped with hardware and software for controlling the electric or electronic devices. When there is an error in the hardware or software, the vehicle may compensate for the error of the hardware or correct the error of the software through update of the software.

The vehicles may detect an error in hardware or software using a fail safety logic installed in an electric or electronic device, and upon detecting an error, update the entire software of the device.

However, in an autonomous navigation vehicle, a connected car, an electric vehicle, and the like, functions of respective electric or electronic devices interoperate with each other in a complicating manner. Thus, when an error is detected from a specific device and the electric or electronic device is subjected to partial software update, additional errors may occur during the interoperation between the various electric or electronic devices.

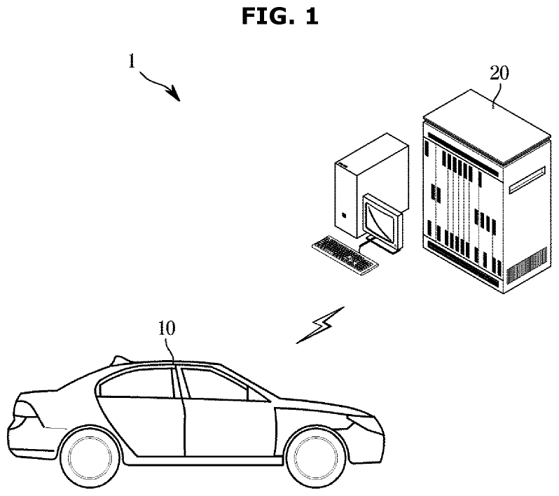

FIG. 1 is a diagram illustrating a software update system 1 according to one embodiment.

Referring to FIG. 1, the software update system 1 includes a vehicle 10 and a server apparatus 20.

The vehicle 10 may run on a road or a railroad using fossil fuel, electricity, and the like as a power source.

The vehicle 10 may be provided with a plurality of electric or electronic devices that provide convenience and safety to the driver. For example, the vehicle 10 may be provided with a convenience device, such as an audio/video/navigation (AVN) device, a heating ventilation air conditioning (HVAC) device, and the like. In addition, the vehicle 10 may be also provided with other devices that are related to running of the vehicle, such as an engine management system (EMS), a transmission control unit (TCU), an electronic stability control (ESC), a motor driven power steering (MDPS), and the like. The plurality of electric or electronic devices installed in the vehicle 10 may each include a sensor, an actuator, and an electronic control unit (ECU). The sensor may obtain environmental information and/or operation information of the vehicle 10, and the actuator may drive the vehicle 10. The ECU may control the actuator based on an output of the sensor.

The vehicle 10 is an apparatus directly associated with the safety and life of the driver and/or the passenger, and requires the integrity of the operation of the devices (mechanical devices and electric or electronic devices) included in the vehicle 10. Due to a small error of the electric or electronic devices, the safety and life of the driver and/or passengers may be seriously threatened.

However, an unexpected situation frequently occurs during running of the vehicle 10, and a situation that a designer of the vehicle has not expected in advance may occur. As such, the mechanical devices and/or electric or electronic devices of the vehicle 10 may malfunction in a situation unexpected in advance. In order to prevent, compensate for or correct malfunctions of the mechanical devices and/or electric or electronic devices of the vehicle 10, the vehicle 10 may be subject to update.

The electric or electronic devices of the vehicle 10 may be provided with hardware and software for controlling each part of the vehicle 10. The hardware may include a sensor, an actuator, a processor, a memory and the like installed in each of the electric or electronic devices, and the software may include programs and/or data stored or memorized in the processor and/or the memory.

Update of the vehicle 10 may include update of the software. For example, updating the software may include replacing the programs and/or data installed in the ECU with new programs and/or new data.

According to such software update, the vehicle 10 may compensate for, correct, or prevent errors in hardware and/or existing software.

The vehicle 10 may communicate with the server apparatus 20 for software update.

The vehicle 10 may transmit environmental information and/or operation information of the vehicle 10 to the server apparatus 20 for software update. For example, the vehicle 10 may transmit sensing data sensed by various sensors and/or driving data for driving the actuator to the server apparatus 20.

The vehicle 10 may receive a program and data for software update from the server apparatus 20. For example, the vehicle 10 may receive a program and data for updating software installed in the respective ECUs.

The server apparatus 20 may communicate with the vehicle 10. The server apparatus 20 may receive the environmental information and/or operation information of the vehicle 10 from the vehicle 10 and may transmit a program and data for software update of the vehicle 10 to the vehicle 10.

The server apparatus 20 may store a vehicle model for simulating the running and operation of the vehicle 10 and software that is the same as software installed in the vehicle 10. For example, the server apparatus 20 may store the same software as software installed in the vehicle 10, and may include information of a mechanical model and/or an electric model of the vehicle 10 for simulating the software installed in the vehicle 10.

The server apparatus 20 may receive environmental information and/or operation information of the vehicle 10 from the vehicle 10 and may apply the received environmental information and/or operation information of the vehicle 10 to the software, which is the same as the software installed in the vehicle 10, to simulate the running and operation of the vehicle 10. In addition, the server apparatus 20 may apply a result processed by the same software as that installed in the vehicle 10 to the vehicle model, and predict running and/or operation of the vehicle 10.

While simulating the running and operation of the vehicle 10, the server apparatus 20 may detect an error in the environmental information and/or operation information of the vehicle 1, an error in the same software as that installed in the vehicle 10, and an error of the mechanical device and/or the electric device of the vehicle 10 based on the vehicle model.

When an error of the vehicle 10 is detected while simulating the running and operation of the vehicle 10, the server apparatus 20 may generate update data of the software to remove the error of the vehicle 10.

In addition, the server apparatus 20 may transmit the software update data to the vehicle 10.

The vehicle 10 may update the software of the vehicle 10 based on the software update data received from the server apparatus 20.

Hereinafter, the configuration and operation of the vehicle 10 and the server apparatus 20 will be described in detail below.

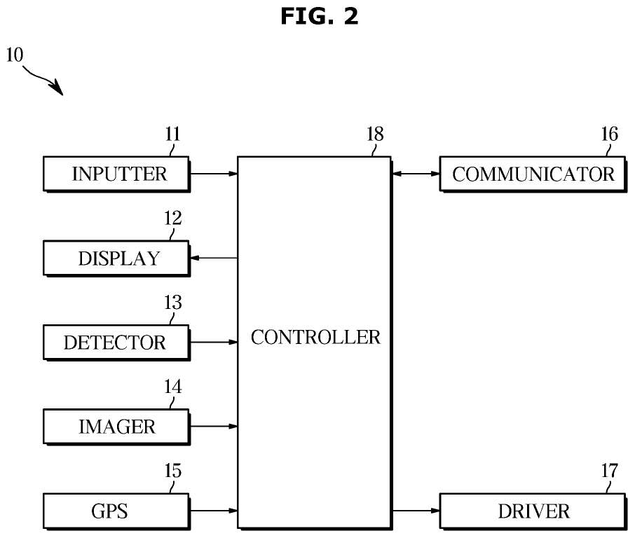

FIG. 2 is a diagram illustrating an example of the vehicle 10 according to an embodiment.

Referring to FIG. 2, the vehicle 10 includes an inputter 11, a display 12, a detector 13, an imager 14, a global position system (GPS) 15, a communicator 16, a driver 17, and a controller 18.

The inputter 11 may receive one or more inputs related to running and communication of the vehicle 10 from the driver. The inputter 11 may receive a request for upgrading the software of the vehicle 10 from the driver via Wi-Fi communication, or receive a request for traffic information via V2X communication.

The inputter 11 may include a plurality of switches for receiving an input of the driver. In addition, the inputter 11 may include a push switch and a membrane switch operated by being pressed by the user, or a touch switch operated in contact with a part of the user's body.

The display 12 may display information about the running and communication of the vehicle 10 to the driver. The display 12 may display a progress of software upgrade through Wi-Fi communication or display traffic information of surrounding roads received through V2X communication.

The display 12 may include various types of display panels for displaying information related to the running and communication of the vehicle 1. For example, the display 12 may include a light emitting diode (LED) panel, an organic light emitting diode (OLED) panel, a liquid crystal display (LCD) panel, and the like.

In addition, the display 12 may employ a touch screen panel (TSP) that receives an input from the driver and displays operation information corresponding to the received control command.

The touch screen panel includes a display for displaying operation information and/or a control command, a touch panel for detecting coordinates of a contact with a part of the user's body, and a touch screen controller for determining the control command input by the user based on the coordinates of the contact detected by the touch panel. The touch screen controller may compare the coordinates of a touch of the user detected through the touch panel with the coordinates of a control command displayed through the display to thereby recognize the control command input by the user.

The detector 13 detects state information of the vehicle 10.

The detector 13 may include at least one of an angular velocity detector for detecting the angular velocity of a steering wheel for detecting a steering angle of the vehicle 10, a velocity detector for detecting the running velocity of the vehicle 10, a yaw rate detector for detecting a yaw moment of the vehicle 10, and an acceleration detector for detecting an acceleration of the vehicle 10.

The velocity detector may represent wheel velocity sensors that are provided on front, rear, right, and left wheels, or an acceleration sensor for detecting the acceleration of the vehicle 10.

The detector 13 may include a distance detector that detects a distance to an object located outside the vehicle 10, for example, another vehicle running in front of the vehicle 1, a stationary object, such as a structure installed in the vicinity of the road, and another vehicle approaching the vehicle in the opposite lane.

The distance detector outputs one or more signals corresponding to detection of objects existing on the front side and left and right sides of the vehicle 10 at the current position of the vehicle 1, and transmits a signal corresponding to the distance to the detected object to the controller 18.

Such a distance detector may include a light detection and ranging (Lidar) sensor. The lidar sensor may be a non-contact distance detection sensor using the principle of a laser radar.

The distance detector may include an ultrasonic sensor or a radar sensor.

The imager 14 obtains an image of the road and transmits the obtained image to the controller 18. Here, the image of the road may be an image of the road in a forward direction with respect to the running direction of the vehicle 1.

In detail, the imager 14 is an apparatus for detecting object information and converting the detected object information into an electrical image signal. The imager 14 detects an environment of an outside of the vehicle 10 at the current position of the vehicle 10, in particular, information about a road on which the vehicle 10 is running, and information about surrounding objects existing in the front side and the left and right sides of the vehicle 10, and transmits the detected object information to the controller 18.

The imager 14 is a camera that may include a charge coupled device (CCD) or a complementary metal-oxide semiconductor (CMOS) image sensor.

The imager 14 may be provided on a window glass on the front side, in detail, on a window glass inside the vehicle 10, on a rear mirror inside the vehicle 10 or a roof panel to be exposed to the outside.

The imager 14 may be a rear camera or a camera for a black box, or may be a camera for an autonomous driving control device provided for autonomous driving.

The GPS 15 may receive position information provided from a plurality of satellites to obtain current position information of the vehicle 10. The GPS 15 may include an antenna for receiving signals of a plurality of GPS satellites, software for obtaining the position of the vehicle 10 using distance and time information corresponding to position signals from the plurality of GPS satellites, and an outputter for outputting the obtained current position information of the vehicle 10.

The communicator 16 may perform communication with the server apparatus 20. The communicator 16 may transmit a communication signal received from the server apparatus 20 to the controller 18. The communicator 16 may transmit a communication signal corresponding to state information, detection information of the vehicle 1, and input information input by the user to the server apparatus 20 based on a control command of the controller 18.

The communicator 16 may communicate with the server apparatus 20 in various communication schemes.

For example, the communicator 16 may communicate with the server apparatus 20 using a time division multiple access (TDMA), a code division multiple access (CDMA), a wideband code division multiple access (WCDMA) (CDMA2000), wireless broadband (Wibro), world interoperability for microwave access (WiMAX), long term evolution (LTE), or wireless broadband evolution. In addition, the communicator 16 may communicate with the server apparatus 20 using a dedicated short range communication (DSRC) communication scheme, a wireless access in vehicular environments (WAVE) communication scheme, or a wireless fidelity (WiFi) communication scheme.

The driver 17 is a device for driving the vehicle 10, and may include a braking device, a suspension device, a power generating device, a power transmitting device, and a steering device.

The controller 18 is provided in the vehicle 10, and controls the various drivers 17 and additional devices provided in the vehicle 1. The controller 18 may be provided in an autonomous driving control device for autonomous drive.

The controller 18 controls autonomous driving of the vehicle 10 based on user input information of the inputter 11, image information of the imager 14, detection information of the detector 13, position information of the GPS 15, and information received through the communicator 16.

The controller 18 checks the current position received by the GPS 15 in response to receiving a selection signal of a navigation mode selected through the inputter 11, checks a destination selected through the inputter 11, checks map information stored in the memory, searches a route from the current position to the destination, matches the found route and the map, and allows the display 12 to display the map matching the route.

The controller 18, in response to receiving a selection signal of an autonomous driving mode, performs interoperation with the navigation mode, and controls driving of the driver 17 based on navigation information, image information, distance information, velocity information, and external information to perform autonomous running from the current position to the destination.

The controller 18 checks the positions of other vehicles running in the left and right lanes of the lane of the vehicle 10 based on information about a distance to an obstacle detected by the distance detector during the autonomous driving mode, checks the distance to the other vehicle corresponding to the checked position of the other vehicle, and adjusts the velocity of the vehicle 10 based on the checked distance of the other vehicle.

The controller 18, in response to receiving image information of a road during the autonomous driving mode, recognizes a lane line on the road by performing image processing, and recognizes a lane on which the vehicle 10 runs based on position information of the recognized lane line.

The controller 18 may control the running direction (i.e., steering) of the vehicle 10 such that the lane is maintained or changed based on the distance to the other vehicle, the current position, the recognized lane line, the recognized lane, and the searched route during the autonomous driving mode.

The controller 8 may display front, rear, left side and right side views of the vehicle 10 obtained through the imager 14 during the autonomous driving mode, and may control the display 12 to display map information that matches a route and road guidance information in association with the navigation mode.

Here, the navigation information may include destination information and map information, and may further include the name of a road, location information of a road, a type of a road, and a route number of a road in the map

The controller 18 performs a manual driving mode when the autonomous driving mode is cancelled. That is, the controller 18 controls the power device and the braking device based on operation information of a brake pedal and an accelerator pedal manipulated by the driver during the manual driving mode such that the velocity of the vehicle 10 is adjusted, and controls the steering device based on steering information of a steering wheel manipulated by the driver such that the running direction of the vehicle 10 is adjusted.

The controller 18 may control the display 12 to display forward traffic information transmitted from another vehicle, access information of other vehicles, and collision prediction information during running.

The controller 18 may control a loudspeaker to output forward traffic information transmitted from another vehicle, access information of other vehicles, and collision prediction information as sound during running.

The controller 18 may transmit environmental information and/or operation information of the vehicle 10 to the server apparatus 20 through the communicator 16 and receive environmental information and operation information of other vehicles through the communicator 16. The controller 18 may control the operation of at least one of the driving device and the additional device of the vehicle 10 based on the received information. Here, the environmental information may include forward traffic information, distance information with respect to other vehicles, and the like.

The controller 18 may communicate with the server apparatus 20 through the communicator 16 for software update. The controller 18 may transmit environmental information and/or operation information of the vehicle 10 to the server apparatus 20 through the communicator 16 for software update.

The controller 18 may receive a program and data for software update from the server apparatus 20 through the communicator 16. In addition, the controller 18 may apply the program and data for software update received from the server apparatus 20 to software stored in the controller 18, and update the software.

It should be understood that at least one component shown in FIG. 2 may be added or omitted corresponding to the performances thereof, and the mutual positions of the components may be changed corresponding to the performance or structure of the system.

Each component shown in FIG. 2 may refer to a software component and/or a hardware component, such as a field programmable gate array (FPGA) and an application specific integrated circuit (ASIC).

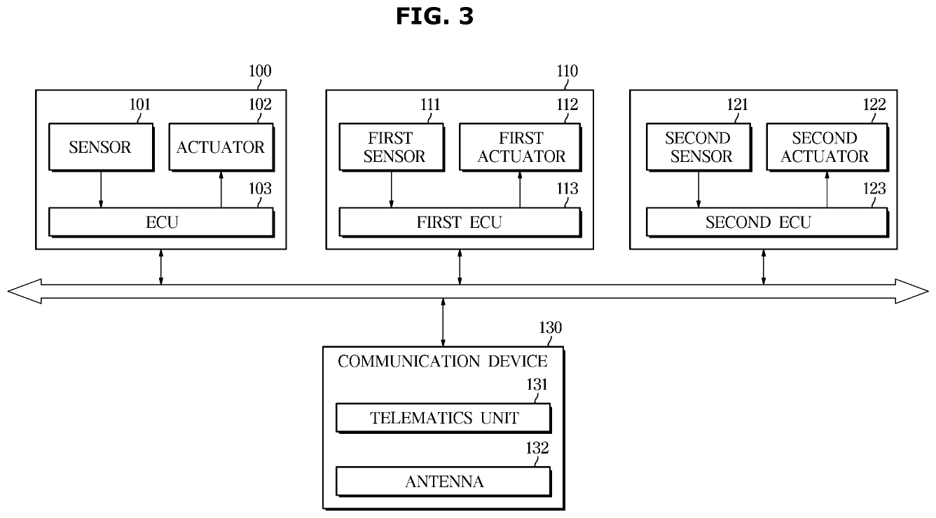

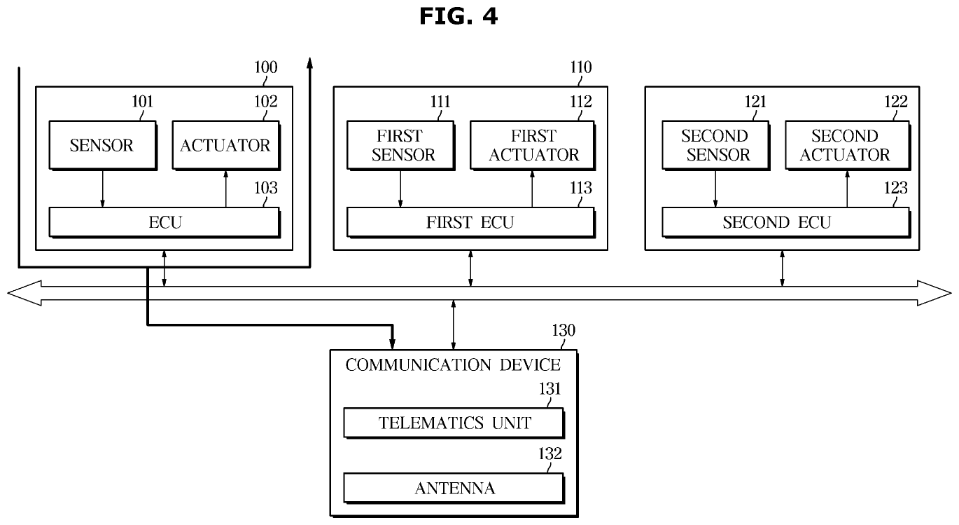

FIG. 3 is a diagram illustrating a configuration of a vehicle according to an embodiment. FIG. 4 is a diagram illustrating an example in which vehicle related information is transmitted to a server apparatus according to an embodiment.

The vehicle 10 includes a plurality of electric devices. For example, the vehicle 10 may include a communication device 130 for communicating with the server apparatus 20 as shown in FIGS. 3 and 4. In addition, the vehicle 10 may also include an electric device 100, a first electric device 110, and a second electric device 120. The electric device 100, the first electric device 110, and the second electric device 120 may each be a different electric device. For example, the electric device 100, the first electric device 110, and the second electric device 120 may represent an audio/video/navigation device, an air conditioner, an engine management system, a transmission control unit, an electronic stability control (ESC), and a motor-driven power steering.

The communication device 130, the electric device 100, the first electric device 110, and the second electric device 120 are connected through a vehicle communication network (network technology: NT). For example, the communication device 130, the electric device 100, the first electric device 110, and the second electric device 120 may be communicate with each other via Ethernet, media oriented systems transport (MOST), Flexray, controller area network (CAN), local Interconnect network (LIN), and the like.

The electric device 100 may include a sensor 101, an actuator 102, and an electronic control unit (ECU) 103.

The sensor 101 may collect environmental information and/or operation information of the vehicle 10. For example, the sensor 101 may be a temperature sensor, an illuminance sensor, a timer, and the like, and may collect environmental information, such as ambient temperature, illuminance, and time. In addition, the sensor 101 may collect traffic information, such as information about distances to other vehicles.

The sensor 101 may be an accelerator pedal sensor, a braking pedal sensor, a velocity sensor, a steering angle sensor, an acceleration sensor, a yaw sensor, and the like, and may collect information related to the running of the vehicle 10, such as an acceleration intention and a braking intention, of the driver and a running velocity, a steering angle, an acceleration and a yaw rate, of the vehicle 10.

The sensor 101 is electrically connected to the ECU 103, and may transmit sensing data to the ECU 103.

The actuator 102 is electrically connected to the ECU 103 and operates mechanically or electrically in response to a control command of the ECU 103.

For example, the actuator 102 may be a valve, a motor, or the like. The actuator 102 may close or open a flow path in response to a control command of the ECU 103 and may also generate a torque (rotation) in response to a control command of the ECU 103.

The ECU 103 is connected to the sensor 101 and the actuator 102. The ECU 103 may process the sensing data of the sensor 101 and generate control data for controlling the actuator 102. For example, the ECU 103 may receive a displacement of the accelerator pedal from the accelerator pedal sensor and generate control data for controlling the opening degree of a throttle valve of the engine in response to the displacement of the accelerator pedal.

The ECU 103 may transmit the sensing data received from the sensor 101 to the communication device 130 through the vehicle communication network NT as shown in FIG. 4. In addition, the ECU 103 may transmit control data to be output to the actuator 102 to the communication device 130 through the vehicle communication network NT. The sensing data and the control data may correspond to the environmental information and the operation information of the vehicle 10, respectively.

In addition, the ECU 103 may store software for processing sensing data and generating control data. The ECU 103 may receive data for updating the software from the communication device 130 and may update the software based on the software update data.

The first and second electric devices 110 and 120 include first and second sensors 111 and 121, first and second actuators 112 and 122, and first and second ECUs 113 and 123.

Each of the first and second electric devices 110 and 120 may perform a function different from a function performed by the electric device 100. The first and second electric devices 110 and 120 may transmit pieces of sensing data sensed by the first and second sensors 111 and 121 and pieces of control data generated by the first and second ECUs 113 and 123 to the communication device 130 through the vehicle communication network NT.

The electric device 100 and the first and second electric devices 110 and 120 are only examples of the electric device included in the vehicle 10, and the electric or electronic device included in the vehicle 10 is not limited to the illustration of FIG. 3.

The communication device 130 is connected to the electric device 100 and the first and second electric devices 110 and 120 through the vehicle communication network NT.

The communication device 130 includes a telematics unit 131 and an antenna 132.

The telematics unit 131 may receive sensing data and control data from each of the electric device 100 and the first and second electric devices 110 and 120 through the vehicle communication network NT and process the sensing data and control data. For example, the telematics unit 131 may modulate the sensing data and the control data into a transmission signal.

The telematics unit 131 may output the transmission signal to the antenna 132 such that the transmission signal is transmitted to the server apparatus 20.

The telematics unit 131 may receive a reception signal from the antenna 132 and demodulate the received signal. The received signal may include, for example, software update data, and the telematics unit 131 may demodulate the received signal into the software update data.

In addition, the telematics unit 131 may transmit the software update data to the electric device 100 and the first and second electric devices 110 and 120 through the vehicle communication network NT.

The antenna 132 may emit radio waves into the free space and may receive radio waves from the free space.

The antenna 132 may receive a transmission signal from the telematics unit 131 and emit radio waves corresponding to the transmission signal to the free space.

Further, the antenna 132 may receive radio waves from the free space and may transmit a reception signal corresponding to the received radio waves to the telematics unit 131.

The communication device 130 receives sensing data and control data from each of the electric device 100 and the first and second electric devices 110 and 120 as shown in FIG. 4, and may wirelessly transmit a transmission signal corresponding to the received control data to the server apparatus 20. In addition, the communication device 130 may wirelessly receive a reception signal from the server apparatus 20, and may transmit software update data included in the reception signal to the electric device 100 and the first and second electric devices 110 and 120.

As such, the vehicle 10 may transmit environmental information and/or operation information (for example, sensing data and/or control data) of the vehicle 10 to the server apparatus 20, and receive software update data from the server apparatus 20. In addition, the vehicle 10, in response to receiving the software update data, may update software of each electric device.

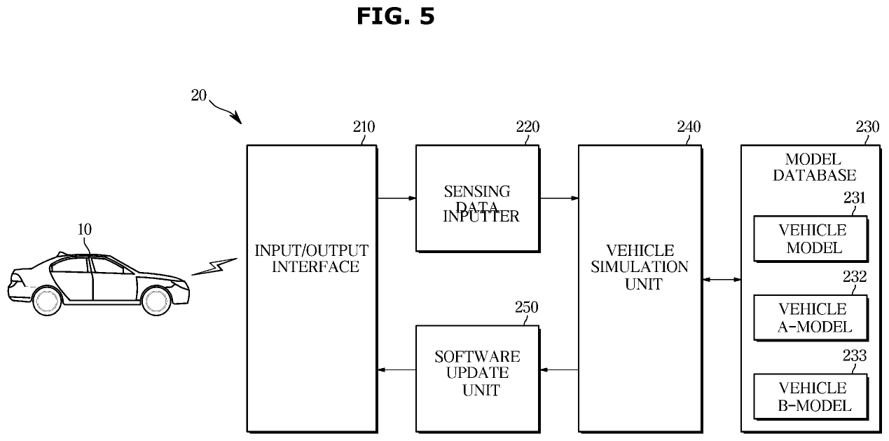

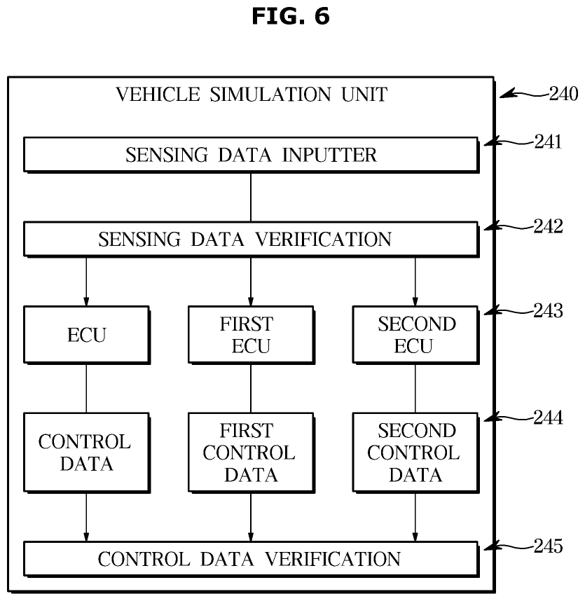

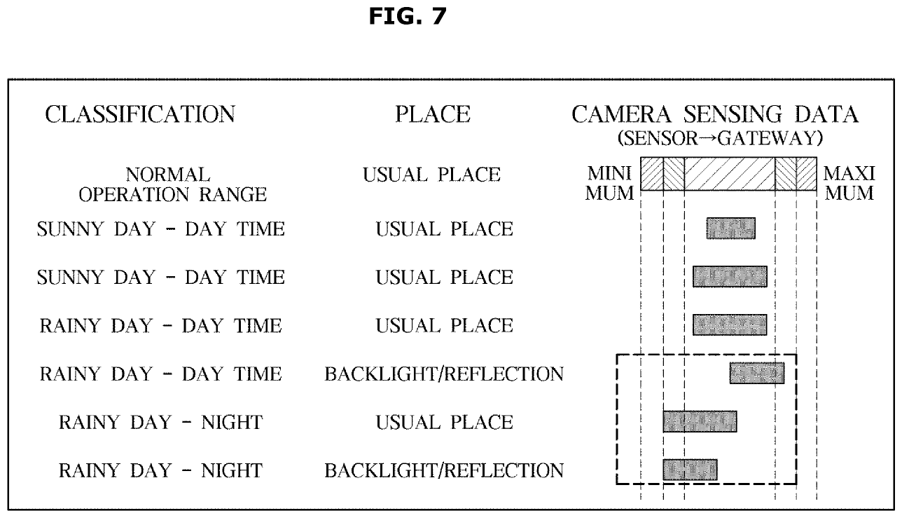

FIG. 5 is a diagram illustrating a configuration of a server apparatus according to an embodiment. FIG. 6 is a diagram illustrating an example in which a server apparatus detects an error of a vehicle according to an embodiment. FIG. 7 is a diagram illustrating an example in which a server apparatus verifies sensing data of a vehicle according to an embodiment.

Referring to FIGS. 5, 6, and 7, the server apparatus 20 includes an input/output interface 210, a sensing data inputter 220, a model database 230, a vehicle simulation unit 240, and a software update unit 250.

The input/output interface 210 may receive sensing data of the sensor 101 and control data of the ECU 103 that are transmitted from the vehicle 10, and may transmit software update data to the vehicle 10.

For example, the server apparatus 20 may be connected to the Internet, which is a wide area network, and the input/output interface 210 may receive the sensing data of the sensor 101 and the control data of the ECU 103 through the Internet (or from the Internet). In addition, the input/output interface 210 may transmit software update data through the Internet (or to the Internet).

The input/output interface 210 may transmit the sensing data and the control data to the sensing data inputter 220 through the Internet (or from the Internet). The input/output interface 210 is also electrically connected to the software update unit 250, receives software update data from the software update unit 250, and transmits the software update data to the vehicle 10.

The sensing data inputter 220 receives the sensing data and the control data from the input/output interface 210, and converts the received sensing data and control data into a form to be processed by the vehicle simulation unit 240. In addition, the sensing data inputter 220 may transmit the converted sensing data and control data to the vehicle simulation unit 240.

The model database 230 may store information of a vehicle model 231 of the vehicle 10.

The vehicle model 231 may be used for the server apparatus 20 to predict an operation of the vehicle 10. For example, the vehicle simulation unit 240 may apply the sensing data to the vehicle model 231 and predict the operation of the vehicle 10 based on an output of the vehicle model 231.

The vehicle model 231 may include various pieces of software installed in the electric devices of the vehicle 10. For example, the vehicle model 231 may include software installed in the electric device 100 of the vehicle 10, software installed in the first electric device 110 of the vehicle 10, and software installed in the second electric device of the vehicle 10 120.

The vehicle model 231 may include operation parameters of various mechanical devices and electric devices included in the vehicle 10. For example, the vehicle model 231 may include a parameter of the engine installed in the vehicle 10, a parameter of the steering device, a parameter of the brake, a parameter of the valve, a parameter of the motor, and the like.

The model database 230 may store not only the vehicle model 231 of the vehicle 10, but also vehicle models of other vehicles. The model database 230 may further store a vehicle A-model 232 of vehicle A and a vehicle B-model 233 of vehicle B.

The vehicle simulation unit 240 may verify the sensing data received from the vehicle 10, and predict the operation of the vehicle 10.

The vehicle simulation unit 240 may receive sensing data of the vehicle 10 from the sensing data inputter 220 (241) and may verify the sensing data of the vehicle 10 (242) as shown in FIG. 6.

The vehicle simulation unit 240 may determine whether the sensing data received from the vehicle 10 is within a predetermined normal range.

For example, the vehicle simulation unit 240 may receive camera sensing data of the vehicle 10 and may determine whether the camera sensing data is within a predetermined normal range. Referring to FIG. 7, the vehicle simulation unit 240 may determine that the camera sensing data is out of a normal range under a condition of rainy day-daytime-backlight/reflection. Further, the vehicle simulation unit 240 may determine that the camera sensing data is out of a normal range under a condition of a rainy day-night time-usual light source.

When the sensing data is out of the normal range, the vehicle simulation unit 240 may determine that the sensor 101 provided in the vehicle 10 or the software processes data of the sensor 101 has an error.

The vehicle simulation unit 240 may predict the operation of the vehicle 10 based on the vehicle model 231 of the model database 230 and the sensing data of the vehicle 10 (243) as shown in FIG. 6. For example, the vehicle simulation unit 240 may input sensing data of the vehicle 10 to software of the ECU 103 included in the vehicle model 231, and generate control data for controlling the actuator 102 based on an output of the software (244).

The vehicle simulation unit 240 may verify control data as shown in FIG. 6 (245).

The vehicle simulation unit 240 may compare control data received from the vehicle 10 with the control data generated from the vehicle model 231. The vehicle simulation unit 240 may determine an error of the software installed in the vehicle 10 based on a result of the comparison between the control data received from the vehicle 10 and the control data generated from the vehicle model 231.

The vehicle simulation unit 240 may simulate driving of the actuator 102 based on the verified control data as shown in FIG. 6.

The vehicle simulation unit 240 may predict the operations of the components included in the vehicle 10, such as the engine, the steering device, the brake, the valve, and the motor, based on the control data generated from the vehicle model 231. The vehicle simulation unit 240 may determine whether the software installed in the vehicle 10 and/or the actuator 102 has an error based on the predicted operation of the vehicle 10. For example, when the predicted operation of the vehicle 10 is out of a predetermined normal range, the vehicle simulation unit 240 may determine that the software installed in the corresponding ECU and/the actuator 102 connected to the corresponding ECU has an error.

The vehicle simulation unit 240 may transmit information about the detected error to the software update unit 250. For example, the vehicle simulation unit 240 may transmit information about an error in the software and/or hardware installed in the electric devices of the vehicle 10 to the software update unit 250.

The software update unit 250 may receive the information about the error of the software and/or hardware of the vehicle 10 from the vehicle simulation unit 240, and generate software update data for removing the error of the software of the vehicle 10 or compensating for the error of the hardware of the vehicle 10.

The software update unit 250 may transmit the software update data to the input/output interface 210, and the input/output interface 210 may transmit the software update data to the vehicle 10.

In addition, the software update unit 250 may transmit the software update data to the model database 230, and the model database 230 may update the vehicle model 231 based on the software update data.

As such, the server apparatus 20 may receive the sensing data and the control data from the vehicle 10. The server apparatus 20 may verify the sensing data and may predict control data of the ECU 103 included in the vehicle 10 using the sensing data and the vehicle model. The server apparatus 20 may verify control data received from the vehicle 10 using the predicted control data, and predict the operation of the vehicle 10 using the control data and the vehicle model. The server apparatus 20 may determine an error in the hardware and/or software installed in the vehicle 10 based on the verification of sensing data, the verification of control data, and the prediction of operation of the vehicle 10.

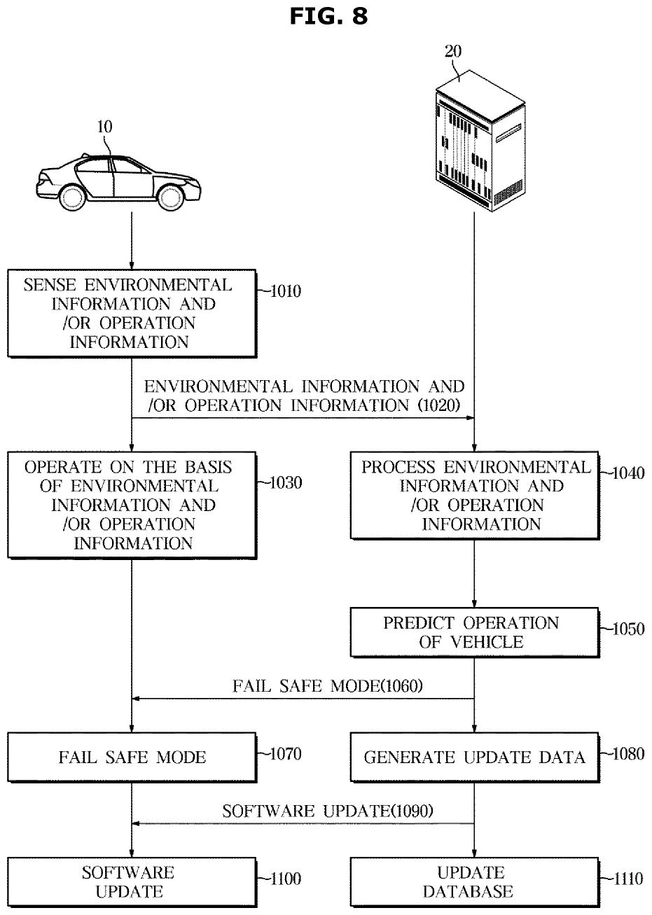

FIG. 8 is a diagram illustrating an example of an operation of a software update system according to one embodiment.

Referring to FIG. 8, the vehicle 10 senses environmental information and/or operation information (1010).

The vehicle 10 may sense environmental information and/or operation information through the sensor 101.

The sensor 101 may collect environmental information, such as ambient temperature, illuminance, time, and the like. In addition, the sensor 101 may collect traffic information, such as information about distances to other vehicles. In addition, the sensor 101 may collect information related to running of the vehicle 10, such as acceleration intention and braking intention, of the driver, and running velocity, steering angle, acceleration and yaw rate of the vehicle 10.

The vehicle 10 transmits the environmental information and/or operation information (1020).

The vehicle 10 may wirelessly transmit the environmental information and/or the operation information to the server apparatus 20 through the communication device 130.

The vehicle 10 operates based on environmental information and/or operation information (1030).

The vehicle 10 may process the environmental information and/or operation information, and may control the operation of the actuator 102 included in the vehicle 10 based on environmental information and/or operation information. For example, the vehicle 10 may control an engine, a steering device, a brake, and the like based on environmental information and/or operation information.

The server apparatus 20 processes the environmental information and/or operation information received from the vehicle 10 (1040).

The server apparatus 20 may verify the environmental information and/or operation information received from the vehicle 10.

For example, the server apparatus 20 may determine whether the environmental information and/or operation information received from the vehicle 10 is within a predetermined normal range. When the environmental information and/or operation information is out of the normal range, the server apparatus 20 may determine that hardware and/or software of the vehicle 10 has an error.

The server apparatus 20 predicts the operation of the vehicle 10 based on the environmental information and/or operation information received from the vehicle 10 (1050).

The server apparatus 20 may include a vehicle model for simulating the operation of the vehicle 10 and the vehicle model may include the same software as the software installed in the vehicle 10.

The server apparatus 20 may input the environmental information and/or operation information to the software of the vehicle model, and obtain control data that is output from the software of the vehicle model.

The server apparatus 20 may verify the control data.

For example, the server apparatus 20 may determine whether the control data is within a predetermined normal range, and when the control data is out of the normal range, the server apparatus 20 may determine that the hardware and/or software of the vehicle has an error. When the control data output from the vehicle model is different from the control data included in the environmental information and/or operation information, the server apparatus 20 may determine that the hardware and/or software of the vehicle 10 has an error.

The server apparatus 20 may predict the operation of the vehicle 10 based on the control data of the vehicle model. For example, the server apparatus 20 may predict the operations of the components included in the vehicle 10, such as an engine, a steering device, a brake, a valve, and a motor based on the control data of the vehicle model.

The server apparatus 20 may determine whether the software and/or hardware installed in the vehicle 10 has an error based on the predicted operation of the vehicle 10.

The server apparatus 20 requests a fail-safe mode to the vehicle 10 (1060).

When an error in the hardware and/or software of the vehicle 10 is detected, the server apparatus 20 may request a fail-safe mode to the vehicle 10 to update the software of the vehicle 10.

The vehicle 10 enters a fail-safe mode (1070).

The vehicle 10 may switch the ECU 103 to a fail-safe mode in response to the fail-safe mode request of the server apparatus 20. The operation of the ECU 103 in the fail-safe mode may be restricted.

The server apparatus 20 generates software update data (1080).

The server apparatus 20 may generate software update data for removing error in the software of the vehicle 10 or compensating for error in the hardware based on information about the errors in the software and/or hardware of the vehicle 10.

The server apparatus 20 transmits the software update data to the vehicle 10 (1090).

The vehicle 10 updates the software of the ECU 103 (1100).

The vehicle 10 may update the software of the ECU 103 in response to receiving the software update data.

The server apparatus 20 updates the vehicle model (1110).

The server apparatus 20 may update the vehicle model included in the server apparatus 20 based on the software update data.

As described above, the server apparatus 20 simulates the same software as the software of the vehicle 10 based on the environmental information and/or operation information of the vehicle 10, and detects an error of the software of the vehicle 10 based on a result of the simulation.

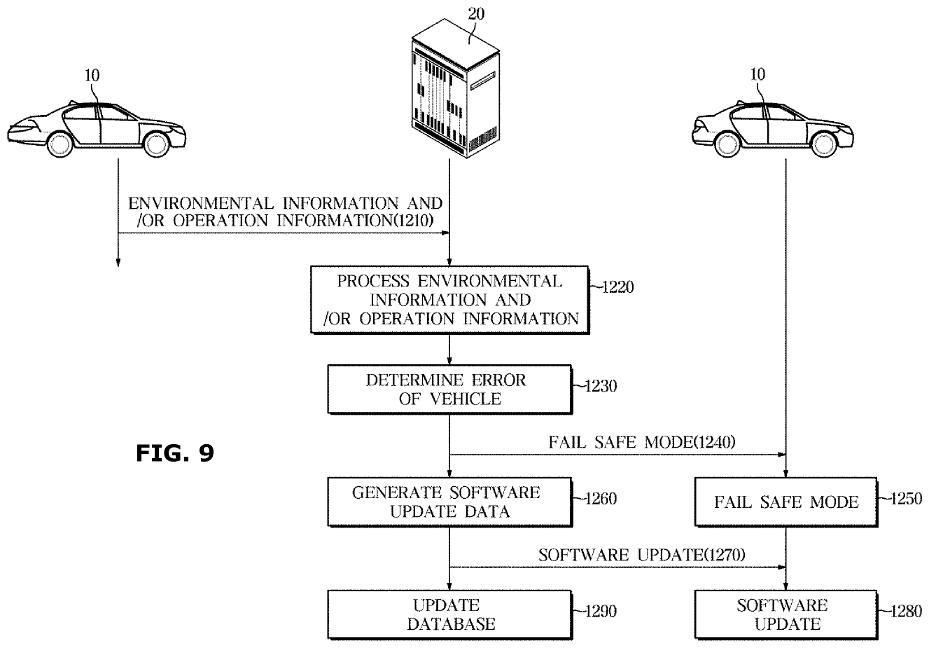

FIG. 9 is a diagram illustrating an example of an operation of a software update system according to another embodiment.

Referring to FIG. 9, the server apparatus 20 receives environmental information and/or operation information from another vehicle 30 (1210). Operation 1210 may be the same as operation 1020 shown in FIG. 8.

The server apparatus 20 processes the environmental information and/or operation information received from the other vehicle 30 (1220). Operation 1220 may be the same as operation 1040 shown in FIG. 8.

The server apparatus 20 determines an error of the vehicle 10 based on the environmental information and/or operation information received from the other vehicle 30 (1230).

The server apparatus 20 may include a vehicle model for simulating the operation of the other vehicle 30, and the vehicle model may include the same software as the software installed in the other vehicle 30.

The server apparatus 20 may input the environmental information and/or operation information to the software of the vehicle model, and obtain control data output from the software of the vehicle model. In addition, the server apparatus 20 may verify the control data.

The server apparatus 20 may predict the operation of the other vehicle 30 based on the control data of the vehicle model. The server apparatus 20 may determine whether software and/or hardware installed in the other vehicle 30 has an error based on the predicted operation of the other vehicle 30.

In addition, the server apparatus 20 may also determine whether the vehicle 10 equipped with the same hardware and software as those of the other vehicle 30 has an error based on the environmental information and/or operation information of the other vehicle 30.

The server apparatus 20 requests a fail-safe mode to the vehicle (1240). Operation 1240 may be the same as operation 1060 shown in FIG. 8.

The vehicle 10 enters a fail-safe mode (1250). Operation 1250 may be the same as operation 1070 shown in FIG. 8.

The server apparatus 20 generates software update data (1260). Operation 1260 may be the same as operation 1080 shown in FIG. 8.

The server apparatus 20 transmits the software update data to the vehicle 10 (1270). Operation 1270 may be the same as operation 1090 shown in FIG. 8.

The vehicle 10 updates the software of the ECU 103 (1280). Operation 1280 may be the same as operation 1100 shown in FIG. 8.

The server apparatus 20 updates the vehicle model (1290). Operation 1290 may be the same as operation 1110 shown in FIG. 8.

As described above, the server apparatus 20 simulates the same software as the software of the other vehicle 30 based on the environmental information and/or operation information of the other vehicle 30, and detects an error in the software of the vehicle 10 equipped with the same software as the software of the other vehicle 30 based on a result of the simulation.

As is apparent from the above, an aspect of the present disclosure can provide a software update system capable of detecting an error in hardware or software in the entire vehicle, and executing software update in response to the error detected.

An aspect of the present disclosure can provide a software update system capable of updating software of a vehicle in association with a server apparatus.

An aspect of the present disclosure can detect an error at a vehicle level, and selectively provides update on desired software.

An aspect of the present disclosure can provide an end-to-end error detection at a vehicle level by operating software having the same structure as that of a vehicle level in the server apparatus. In a vehicle with functions of respective electric devices interoperating with each other in a complicating manner, such as an autonomous vehicle, a connected car, an electric vehicle, and the like, error of software can be efficiently detected.

An aspect of the present disclosure can predict an error having a possibility of occurrence using information about another vehicle, thereby providing software update that removes errors.

An aspect of the present disclosure can significantly improve the performance of the fail safety of the entire vehicle.

Logical blocks, modules or units described in connection with embodiments disclosed herein can be implemented or performed by a computing device having at least one processor, at least one memory and at least one communication interface. The elements of a method, process, or algorithm described in connection with embodiments disclosed herein can be embodied directly in hardware, in a software module executed by at least one processor, or in a combination of the two. Computer-executable instructions for implementing a method, process, or algorithm described in connection with embodiments disclosed herein can be stored in a non-transitory computer readable storage medium.

Although embodiments of the invention have been described above, those skilled in the art may understand that configurations of the various embodiments described above may be changed without departing from the spirit of the invention. It will be also understood that the changes fall within the scope of the invention.

What is claimed is:

1. A software update system comprising:
a server apparatus comprising:
one or more processors;
a communication interface connected to the one or more processor, wherein the communication interface is configured to communicate with a vehicle on which first software is installed; and
a storage configured to store second software that is the same as the first software,
wherein the server apparatus is configured to:
receive environmental information or operation information of the vehicle from the vehicle;
generate update data of the first software based on an output of the second software according to the environmental information or operation information of the vehicle,
transmit the update data of the first software to the vehicle.

2. The software update system of claim 1, wherein the server apparatus is further configured to:
execute the second software using the environmental information or operation information of the vehicle, and
determine an error of the first software based on the output of the second software.

3. The software update system of claim 2, wherein the server apparatus is further configured to determine a validity of the environmental information or operation information of the vehicle, and determine the error of the first software based on a result of the determination on the validity of the environmental information or operation information of the vehicle.

4. The software update system of claim 2, wherein the server apparatus is further configured to determine a validity of the output of the second software according to the input of the environmental information or operation information of the vehicle, and determine the error of the first software based on a result of the determination on the validity of the output of the second software.

5. The software update system of claim 2, wherein the server apparatus is further configured to predict an operation of the vehicle based on the output of the second software and determine the error of the first software based on the operation of the vehicle.

6. The software update system of claim 1, wherein the server apparatus is further configured to update the second software based on the update data of the first software.

7. The software update system of claim 1, wherein the server apparatus is configured to communicate with another vehicle in which third software is installed,
wherein the server apparatus is configured to generate update data of the third software based on the environmental information or operation information of the vehicle and transmit the update data of the third software to the other vehicle.

8. A software update method comprising:
receiving environmental information or operation information from a vehicle in which first software is installed; and
executing second software using the environmental information or operation information received from the vehicle, the second software being the same as the first software;
generating update data of the first software based on an output of the second software according to the environmental information or operation information of the vehicle; and
transmitting the update data of the first software to the vehicle.

9. The software update method of claim 8, wherein the generating of the update data of the first software includes:
inputting the environmental information or operation information of the vehicle to the second software; and
determining an error of the first software based on the output of the second software.

10. The software update method of claim 9, wherein the determining of the error of the first software includes:
determining a validity of the environmental information or operation information of the vehicle; and
determining the error of the first software based on a result of the determination on the validity of the environmental information or operation information of the vehicle.

11. The software update method of claim 9, wherein the determining of the error of the first software includes:
determining a validity of the output of the second software according to the input of the environmental information or operation information of the vehicle; and
determining the error of the first software based on a result of the determination on the validity of the output of the second software.

12. The software update method of claim 9, wherein the determining of the error of the first software includes:
predicting an operation of the vehicle based on the output of the second software; and
determining the error of the first software based on the operation of the vehicle.

13. The software update method of claim 8, further comprising updating the second software based on the update data of the first software.

14. The software update method of claim 8, further comprising:
generating update data of third software installed in another vehicle based on the environmental information or operation information of the vehicle; and
transmitting the update data of the third software to the other vehicle.

15. A software update server comprising:
an input/output interface configured to receive environmental information or operation information of a vehicle in which first software is installed from the vehicle;
a database in which second software that is the same as the first software is stored;
a simulation unit configured to input the environmental information or operation information of the vehicle to the second software and determine an error of the first software based on an output of the second software; and
a software update unit configured to generate update data of the first software based on occurrence of an error of the first software,
wherein the input/output interface is configured to transmit the update data of the first software to the vehicle.

16. The software update server of claim 15, wherein the simulation unit is configured to determine a validity of the environmental information or operation information of the vehicle, and determine the error of the first software based on a result of the determination on the validity of the environmental information or operation information of the vehicle.

17. The software update server of claim 15, wherein the simulation unit is configured to determine a validity of the output of the second software according to the input of the environmental information or operation information of the vehicle, and determine the error of the first software based on a result of the determination on the validity of the output of the second software.

18. The software update server of claim 15, wherein the simulation unit is configured to predict an operation of the vehicle based on the output of the second software and determine the error of the first software based on the operation of the vehicle.

19. The software update server of claim 15, wherein the software update unit is configured to update the second software based on the update data of the first software.

20. The software update server of claim 15, wherein the software update unit is configured to generate update data of third software installed in another vehicle based on occurrence of an error of the first software and transmit the update data of the third software to the other vehicle.
